(19) United States
(12) Patent Application Publication
(10) Pub. No.: US 2010/0081017 A1
(43) Pub. Date: Apr. 1, 2010

(54) MULTIFUNCTIONAL FUEL SYSTEM AND RELATED METHODS

(75) Inventor: Gerard F. McLean, West Vancouver (CA)

Correspondence Address: SCHWEGMAN, LUNDBERG & WOESSNER, P.A., P.O. BOX 2938, MINNEAPOLIS, MN, 55402, US

(73) Assignee: Angstrom Power Incorporated, North Vancouver (CA)

(21) Appl. No.: 12/572,049

(22) Filed: Oct. 1, 2009

Related U.S. Application Data
(60) Provisional application No. 61/101,872, filed on Oct. 1, 2008.

(51) Int. Cl. H01M 8/00

(52) U.S. Cl. 429/13; 429/12; 429/26

(57) ABSTRACT

Embodiments of the invention relate to a multifunctional fuel system, including a multifunctional fuel cartridge including a hydrogen carrier capable of releasing hydrogen and one or more fuel cells, removably coupled to the fuel cartridge. The one or more fuel cells are capable of producing electricity upon receiving hydrogen from the fuel cartridge and wherein the multifunctional fuel cartridge is additionally adapted to release heat.

### CLAIM OF PRIORITY

This patent application claims the benefit of priority of Gerard F. McLean U.S. Provisional Patent Application Ser. No. 61/101,872, (Attorney Docket Number 2269.119PRV), which was filed on Oct. 1, 2008, and which is incorporated herein by reference in its entirety.

### BACKGROUND

Consumers often rely on portable devices to provide numerous functions remote from commercial and residential infrastructure. For example, thermal or electrical services offer heat, lighting, and communication functionalities. For remote use, auxiliary components, such as fuel cartridges and batteries are used to supply such services.

Thermal services and electrical services typically rely on separate infrastructure for fueling or powering each type of service device, imposing a burden on consumers. For many devices, combustible fuels provide thermal services, while batteries of various forms are typically provided for electrical services. It is also possible to provide electrical power from a fuel through the use of a fuel cell.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a schematic view of a multifunctional fuel cartridge system, according to some embodiments.

FIGS. 2A-C illustrate schematic views of multifunctional fuel cartridge system configurations, according to some embodiments.

FIGS. 3A-B illustrate cross-sectional views of a multifunctional fuel cartridge, according to some embodiments.

FIG. 4 illustrates a schematic view of a multifunctional fuel cartridge system including an appliance, according to some embodiments.

### SUMMARY

Embodiments of the invention relate to a multifunctional fuel system, including a multifunctional fuel cartridge including a hydrogen carrier capable of releasing hydrogen and one or more fuel cells, removably coupled to the fuel cartridge. The one or more fuel cells are capable of producing electricity upon receiving hydrogen from the fuel cartridge and wherein the multifunctional fuel system is additionally adapted to release heat.

Embodiments also relate to a multifunctional fuel system including a fuel cartridge capable of releasing hydrogen, a catalytic heater adapted to combust the hydrogen and release heat. The released hydrogen additionally and optionally provides electrical service.

Embodiments further relate to a multifunctional fuel cartridge, including an enclosure adapted to contain a hydrogen carrier capable of releasing hydrogen, a fluidic interface for fluidically coupling the storage device to one or more fuel cells; and a thermal interface for thermally coupling the cartridge to a thermal generator.

Embodiments relate to a method of using a multifunctional fuel system, including releasing hydrogen from a hydrogen carrier contained in a multifunctional fuel cartridge, contacting one or more fuel cells with the hydrogen, generating electrical service from the operation of the one or more fuel cells and generating thermal service from the multifunctional fuel cartridge.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Fuel cells are capable of converting the chemical energy of a fuel to electrical energy at relatively high conversion efficiencies. Fuel cell systems are emerging as attractive candidates for power supplies, owing, at least in part, to the high energy density of fuels. Moreover, fuel cells and fuel storage components may be separated and arranged within the fuel cell system. As a result of greater design flexibility, fuel cell systems can have advantages over batteries.

Embodiments of the invention relate to a system that may deliver thermal services and may deliver electrical services. The system may be capable of converting fuel from a fuel cartridge to electrical energy (e.g., through use of a fuel cell) to deliver electrical services from one or more fuel cells. The fuel may also be converted to thermal energy according to a number of mechanisms.

Embodiments of the invention relate to a multifunctional fuel cartridge that is adaptable to deliver thermal services and electrical services. For example, the cartridge may be configured to work with a thermal generator, a fuel cell, or both. Embodiments of the invention relate to a method of using a multifunctional fuel cartridge to deliver thermal services and electrical services.

### DEFINITIONS

As used herein, “electrochemical cell” refers to a device that converts chemical energy to electrical energy or converts electrical energy to chemical energy. Examples of electrochemical cells may include galvanic cells, electrolytic cells, electrolyzers, fuel cells, batteries and metal-air cells, such as zinc air fuel cells or batteries. Any suitable type of electrochemical cell including fuel cells and appropriate materials can be used according to the present invention including without limitation proton exchange membrane fuel cells (PEMFCs), solid oxide fuel cells (SOFCs), molten carbonate fuel cell (MCFCs), alkaline fuel cells, direct methanol fuel cells, phosphoric acid fuel cells, other suitable fuel cells, and materials thereof.

As used herein, “fluid” refers to a continuous, amorphous substance whose molecules move freely past one another and that has the tendency to assume the shape of its container. A fluid may be a gas, liquefied gas, liquid or liquid under pressure. Examples of fluids may include fluid reactants, fuels, oxidants, and heat transfer fluids. Fluid fuels used in fuel cells may include hydrogen gas or liquid and hydrogen carriers in any suitable fluid form. Examples of fluids include air, oxygen, water, hydrogen, alcohols such as methanol and ethanol, ammonia and ammonia derivatives such as amines and hydrazine, silanes such as disilane, trisilane, disilabutane, complex metal hydride compounds such as aluminum borohydride, boranes such as diborane, hydrocarbons such as cyclohexane, carbazoles such as dodecahydro-n-ethyl carbazole, and other saturated cyclic, polycyclic hydrocarbons, saturated amino boranes such as cyclotriborazane, butane, borohydride compounds such as sodium and potassium borohydrides, and formic acid.

As used herein, “active material particles” refer to material particles capable of storing hydrogen or other fluids or to material particles that may occlude and desorb hydrogen or another fluid. Active material particles may include fluid-storing materials that occlude fluid, such as hydrogen, by chemisorption, physisorption or a combination thereof. Some hydrogen-storing materials desorb hydrogen in response to stimuli, such as change in temperature, change in heat or a change in pressure. Examples of hydrogen-storing materials that release hydrogen in response to stimuli, include metal hydrides, chemical hydrides, suitable micro-ceramics, nano-ceramics, boron nitride nanotubes, metal organic frameworks, palladium-containing materials, zeolites, silicas, aluminas, graphite, and carbon-based reversible fluid-storing materials such as suitable carbon nanotubes, carbon fibers, carbon aerogels, and activated carbon, nano-structured carbons or any combination thereof. The particles may also include a metal, a metal alloy, a metal compound capable of forming a metal hydride when in contact with hydrogen, alloys thereof or combinations thereof. The active material particles may include magnesium, lithium, aluminum, calcium, boron, carbon, silicon, transition metals, lanthanides, intermetallic compounds, solid solutions thereof, or combinations thereof. The active material particles may be formed into a composite hydrogen storage material. Examples of such materials can be found in commonly-owned U.S. patent application Ser. No. 11/379,970, filed Apr. 24, 2006, which is incorporated by reference. As used herein, “occlude” or “occluding” or “occlusion” refers to absorbing or adsorbing and retaining a substance, such as a fluid. Hydrogen may be a fluid occluded, for example. The fluid may be occluded chemically or physically, such as by chemisorption or physisorption, for example. As used herein, “desorb” or “desorbing” or “desorption” refers to the removal of an absorbed or adsorbed substance. Hydrogen may be removed from active material particles, for example. The hydrogen or other fluid may be bound physically or chemically, for example. As used herein, “contacting” refers to physically, chemically, electrically touching or within sufficiently close proximity. A fluid may contact an enclosure, in which the fluid is physically forced inside the enclosure, for example.

As used herein, “hydrogen carrier” may refer to any compound including a hydrogen bond, materials including such compounds, or combinations thereof. Examples of hydrogen carriers include hydrogen, alcohols, such as methanol and ethanol, amines such as ammonia and hydrazine, silanes such as disilane, trisilane, disilabutane, complex compounds such as aluminum borohydride, boranes such as diborane, hydrocarbons such as cyclohexane carbazoles such as dodecahydro-n-ethyl carbazole, and other saturate cyclic, polycyclic hydrocarbons, saturated amino boranes such as cyclotriborazane. Hydrogen carriers can also include saturated hydrocarbons such as cyclohexane and dodecahydron-ethyl carbazole, saturated amino boranes such as cyclotriborazane, carbazoles, and other saturated cyclic hydrocarbons, polycyclic hydrocarbons, aryls, heteroaryls, acyclic hydrocarbons or combinations thereof that can be partially or fully dehydrogenated.

As used herein, “hydrogen generator” refers to a component or components that produce or release hydrogen when activated by a stimulus. Such materials may chemically or physically bind hydrogen or may produce hydrogen as a product of a chemical reaction. One or more catalysts may be utilized with such materials to facilitate the generation of hydrogen. Examples of hydrogen-binding materials include metal hydrides, suitable zeolites, and carbon-based reversible hydrogen-storing materials such as suitable carbon nanotubes, carbon fibres, carbon aerogels, and activated carbon. Examples of materials that may produce hydrogen as a product of a chemical reaction include chemical hydrides, hydrocarbon hydrogen carriers, and other suitable hydrogen-containing compounds, such as ammonia, amine boranes, alcohols such as methanol and ethanol, and formic acid. Such materials may produce hydrogen via any suitable reactions including without limitation thermolysis, hydrolysis, reforming, and electrolysis.

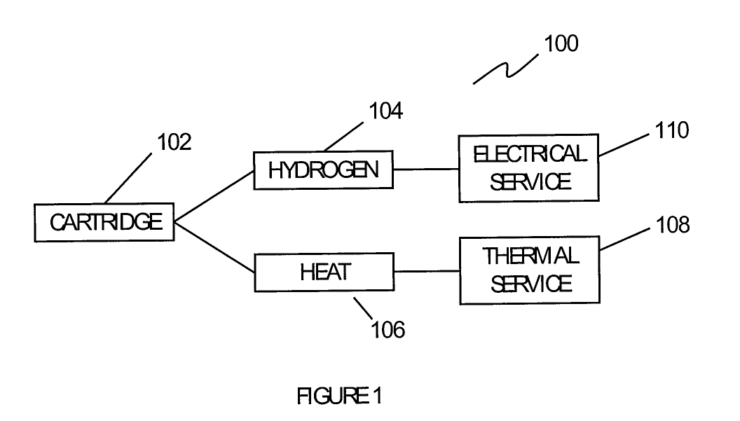

Referring to FIG. 1, a schematic view 100 of a multifunctional fuel cartridge system is shown, according to some embodiments. A multifunctional fuel cartridge 102 may contain a hydrogen carrier capable of releasing hydrogen 104. The fuel cartridge may contain active material particles capable of storing hydrogen. The fuel cartridge 102 may also release heat 106 to be used for thermal services 108. The hydrogen 104 may be used to provide electrical services 110, such as by providing hydrogen to one or more fuel cells to provide a voltage or current. The hydrogen 104 may also be used to produce heat.

To provide electrical services 110, the cartridge 102 may be adaptable for the purpose of providing a fuel which may be converted to electricity. The hydrogen carrier contained in the cartridge 102 may be processed to generate hydrogen that may be fed to a fuel cell to generate electricity and therefore provide electrical services. Electrical services may include using electricity to power resistive heaters, lighting apparatus, USB chargers, fans, or portable electronic devices. To provide thermal services 108, the cartridge 102 may be adapted for the purpose of generating heat.

When used to provide electrical services 110, the cartridge 102 may either release hydrogen (e.g., from a metal hydride, etc.) or contain a hydrogen carrier that may be processed (either within the cartridge or externally, within the fuel cell system) to produce hydrogen. Fuels that can be processed to produce hydrogen include chemical hydrides, metals (hydrolysis or corrosion reactions), silicons (e.g., hydrolysis of silicon) and the like. Any suitable fuel may be used to generate hydrogen gas according to any suitable reaction. For example, hydrogen may be produced by any of hydrolysis (reacting a suitable precursor with water to yield hydrogen), alcoholysis (reacting a suitable precursor with an alcohol to yield hydrogen) or thermolysis (heating a suitable precursor to yield hydrogen). The fuel cartridge may be any enclosure suitable for containing the fuel in question, and/or the reaction to generate the fuel in question. For example, the fuel cartridge may be a fluid enclosure such as the one disclosed in commonly-owned U.S. Pat. No. 7,563,305, or the cellular reservoir disclosed in commonly-owned U.S. Patent Application Publication No. 2007/0178335, the disclosures of which are herein incorporated by reference in their entirety. In still other embodiments, the fuel cartridge may be a hydrogen generating fuel cartridge such as those disclosed in U.S. Pat. No. 7,481,858, or a fuel cartridge such as those disclosed in U.S. Pat. No. 7,172,825, the disclosures of which are herein incorporated by reference in their entirety.

The hydrogen carrier in the cartridge 102 may include any fuel suitable for direct reaction in an electrochemical cell, such as alcohol, methanol, formic acid or a chemical hydride such as sodium borohydride such that the hydrogen carrier may be fed to a fuel cell to generate electricity directly from the hydrogen carrier and therefore provide electrical services. However, this disclosure will describe embodiments that produce electricity from the direct reaction of hydrogen, as examples.

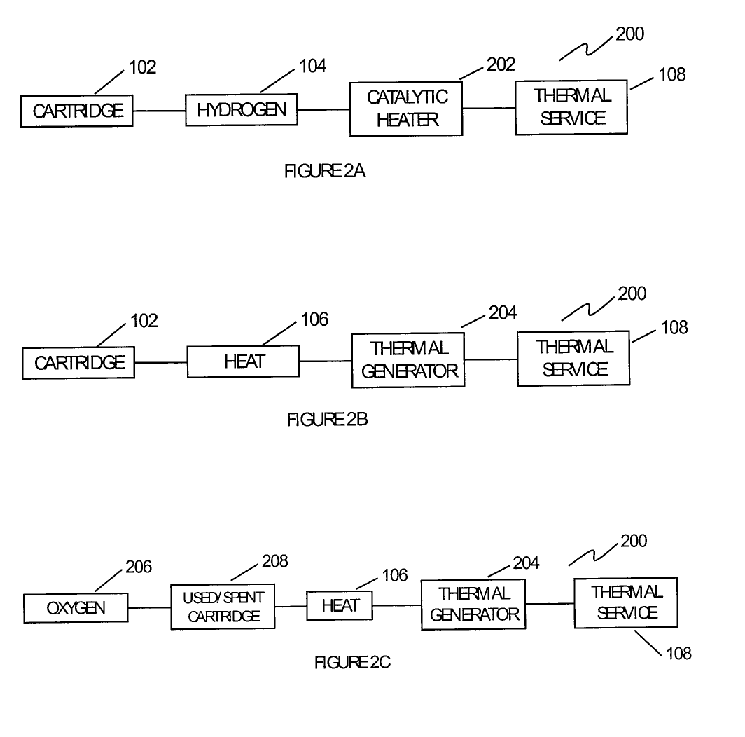

Referring to FIGS. 2A-C, schematic views 200 of multifunctional fuel cartridge system configurations are shown, according to some embodiments. As illustrated in FIGS. 2A-C, the cartridge 102 is shown coupled to a thermal generator 204 so as to deliver thermal services. In some embodiments, although not shown, the cartridge 102 and the thermal generator 204 may be integral with each other.

In embodiments where the system uses hydrogen as fuel, the hydrogen 104 released from the cartridge 102 may be provided to a thermal generator 204 and combusted over a catalyst (i.e., catalytic heater 202) to provide heat and thermal service (see FIG. 2A). In some embodiments, the hydrogen carrier contained in the cartridge may include a non-carbon containing hydrogen carrier and combustion of the fuel may not generate any emissions, such as carbon dioxide or carbon monoxide, which might otherwise be generated if a carbon-containing fuel were used. In certain usage environments, it may be advantageous to utilize a heater which does not generate any such emissions. Examples of fuels suitable for use to generate hydrogen may include, among other things, hydrogen rich chemical feedstocks including chemical hydrides, metals (hydrolysis or corrosion reactions), silicons (e.g., hydrolysis of silicon) and the like. It should be noted that it may be possible to combust other fuels in a similar fashion to generate heat and thermal service.

Examples of cartridges with fuels that can be reacted in cartridges to generate hydrogen can also be found in commonly-owned U.S. patent application Ser. No. 11/288,158 entitled, “HYDROGEN FUEL DELIVERY SYSTEMS,” filed Nov. 29, 2005 and U.S. patent application Ser. No. 11/535,050, filed Sep. 25, 2006 entitled “METHODS AND APPARATUS FOR REFUELING REVERSIBLE HYDROGEN-STORAGE SYSTEMS,” the disclosures of which are herein incorporated by reference.

Heat 106 produced during an exothermic reaction in the cartridge 102 may be transferred to a thermal generator 204 (see FIG. 2B). This heat 106 can be optionally processed. For example, the heat can be upgraded or radiated. Hydrogen 104 generated from these exothermic reactions can be further combusted over a catalyst to produce heat, which can be combined with the heat from the exothermic reaction. Alternately, hydrogen generated from these exothermic reactions can be fed to a fuel cell to produce electricity and electrical services, as discussed above.

In embodiments where at least a portion of the fuel is used as fuel for a fuel cell, the electricity from the fuel cell may be used to power a fan or other mechanism to promote movement of heat generated from one location to another. For example, a fan may be used to promote movement of heat from a thermal generator to the surrounding environment, or may be used to promote movement of heat from the fuel cartridge (e.g. in the case of an exothermic reaction) to the surrounding environment. In other embodiments, the electricity may be used to power a resistive heater, which may be used alone or in combination with the exothermic reaction to provide a thermal service.

In embodiments where a waste product remains in the cartridge 102 from the hydrogen generating reaction, the waste product may be further reacted to produce heat 104. In this instance, the cartridge 102 may be used first to generate hydrogen, to provide electrical services, thermal services, or both, and then sequentially used to generate heat from the waste product. This can be accomplished by allowing the used or spent cartridge 208 to intake air (i.e., oxygen 206) or any other suitable oxidant and facilitate an oxidation reaction of the waste product (see FIG. 2C).

In some embodiments, an activation feature, such as a pull-tab or lever, may be used to initiate the oxidation. Such an activation feature could accomplish a ‘controlled puncture’ of the cartridge 208 to enable the oxidation to commence. In some embodiments, the activation feature could optionally only expose a portion of the waste product to air.

When coupled to a fuel cell to provide electrical services, the electricity from the fuel cells may be optionally used to power an electric heater, such as a resistive heater, and provide thermal services. Furthermore, provision of thermal and electrical services can be alternately or otherwise controlled to use the cartridge for either function within a single appliance.

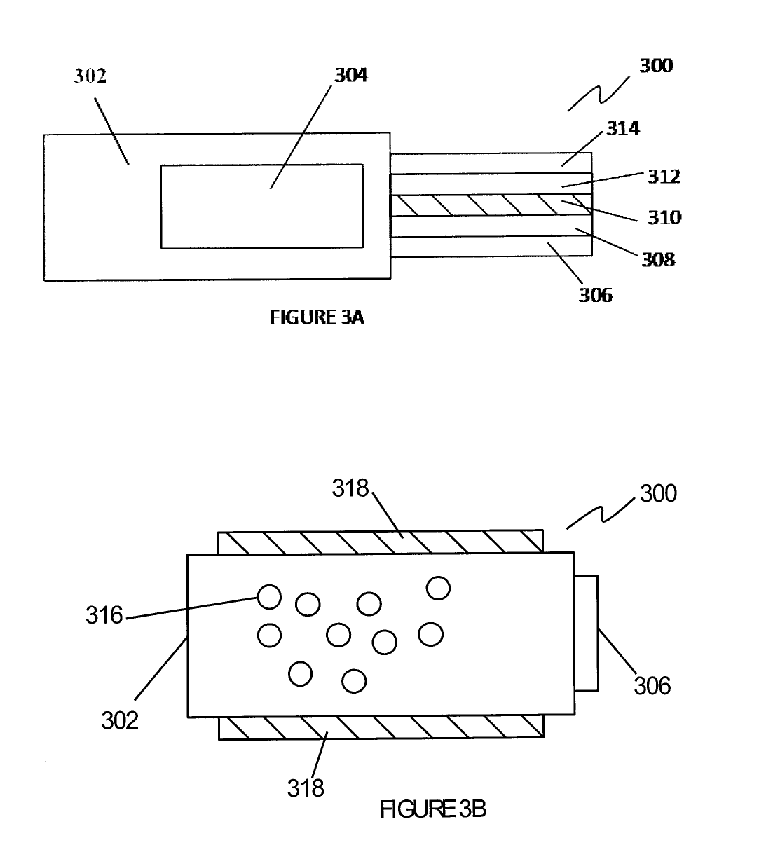

Referring to FIGS. 3A-B, cross-sectional schematics 300 of a multifunctional fuel cartridge is shown, according to some embodiments. The cartridge 302 may optionally integrate fuel processing components 304 to convert the hydrogen carrier contained within the cartridge to hydrogen. When fuel is processed integrally within the cartridge, a number of different components may be integrated in the device to produce hydrogen depending on the fuel type. As one example, the fuel processing system may include a heater. The heater may be used to generate hydrogen from either a thermally-activated fuel/apparatus or an endothermically reactive fuel/apparatus. In some embodiments, a thermally-activated reaction may be a net exothermic process, despite requiring an input of heat to start. As another example, the fuel processing system may include a fluid reservoir containing water, or any other suitable reactant, catalyst, or both, that may be combined with the hydrogen carrier to generate hydrogen. These processing components are non-limiting—any component capable of converting a compatible fuel to hydrogen is within the scope of the invention.

Furthermore, heat or electricity might be advantageously transferred to, from, or between the cartridge and either or both of the thermal generator and fuel cell system when coupled. Therefore, the cartridge 302 may include a fluidic interface 306 with a fluid conduit 308 that optionally integrates thermal 310 and/or electrical 312, 314 transfer conduits. In some embodiments, all or part of the cartridge 302 may be in contact with a thermal interface 318 provided separate from the fluidic interface to facilitate such transfer of thermal energy to or from the cartridge 302. The thermal interface may be in contact with a portion of the surface of the cartridge (e.g. all or part of a side of the cartridge) or may surround all or a portion of the surface of the cartridge or may enclose the cartridge in its entirety. For example, the thermal interface 318 may comprise a sleeve, a wrap, or may be positional proximal to the cartridge. In embodiments where the thermal interface comprises a sleeve or a wrap, the interface may contact the entire length of the cartridge, or may contact a portion of the length of the cartridge. In an embodiment where a cartridge has a round cross-section, the thermal interface 318 may comprise a concentric sleeve which encircles the cartridge, while in an embodiment where a cartridge is prismatic, the thermal interface 318 may contact one, two, three, four or more walls of the cartridge.

For example, when the processing of hydrogen carrier 316 is a net exothermic reaction, heat from the process may be transferred from the cartridge 302 via the thermal interface 318 to the thermal generator (not shown) or may be used to provide thermal services directly (see FIG. 3B). The thermally conductive interface may be integrated with a radiator, a heat pump, or other feature which utilizes the thermal energy to provide thermal services. The thermal interface may include thermally conductive materials to increase heat transfer through the thermal interface. Conversely, the thermal interface may include thermally insular materials to promote heat retention within the cartridge. In some embodiments, the thermal interface may include a combination of thermally conductive and thermally insular materials selectively positioned to influence the flow of thermal energy; in such embodiments, the thermal interface may comprise a layered or a composite structure.

In some embodiments, for example those that oxidize waste product in the spent cartridge or those which contain or generate hydrogen above atmospheric pressure, a pressure regulator or other device for modulating fluid flow may be integrated. In addition, the cartridge may also integrate an electronic circuit for controlling either of the transport mechanisms.

In addition, the fluidic interface 306 may include features that allow coupling of the cartridge to devices having common connection means. Examples of applicable situations and features are also described co-owned U.S. patent application Ser. No. 11/288,158 entitled, “HYDROGEN FUEL DELIVERY SYSTEMS,” filed Nov. 29, 2005, the disclosure of which is herein incorporated by reference. Further examples may be found in the commonly owned U.S. patent application Ser. No. 11/936,662, filed Nov. 7, 2007, entitled “MAGNETIC FLUID COUPLING ASSEMBLIES AND METHODS”, which is incorporated by reference herein in its entirety. Moreover, the fluidic interface 306 may be adapted to be coupled with either a fuel cell system or a thermal generator.

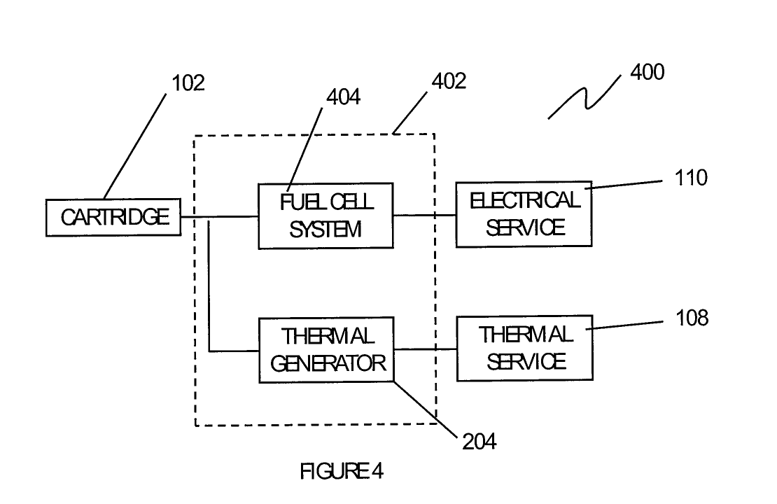

Referring to FIG. 4, a schematic view 400 of a multifunctional fuel cartridge system including an appliance is shown, according to some embodiments. The cartridge 102 may be coupled to a multifunction appliance 402 that is used to selectively power a fuel cell system 404 and a thermal generator 204 so as to control thermal services 108 and electrical services 110 provided by the appliance 402. Furthermore, provision of thermal services 108 may be varied by providing heat via combustion in the thermal generator 204 (i.e. to generate high-grade heat) or via an electric heating element of the generator (i.e. to dissipate low-grate heat).

In some embodiments, the appliance may be configured to provide both thermal 108 and electrical services 110. In such embodiments, the cartridge 102 could provide both fuel to a fuel cell system to provide electrical services 110, and also heat for thermal services 108. Embodiments of an appliance configured to provide both electrical and thermal services may include a combined heater-lantern device, a combined heater-USB charger device, or a combined heater-fan device, for example.

In some embodiments, the cartridge 102 and the thermal generator 204 may be integrated. In such embodiments, the hydrogen carrier contained in the cartridge 102 may release hydrogen by way of a process which has a net result of being exothermic, enabling the cartridge 102 to release hydrogen and function as a thermal generator. The heat generated by the exothermic process may be transferred from the cartridge by way of the thermal interface 318 to provide thermal service 108, while also transferring fuel from the cartridge 102 to the fuel cell system 404 to provide electrical service. In such embodiments, the system may be capable of providing both thermal and electrical service simultaneously, or sequentially.

The above description is intended to be illustrative, and not restrictive. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

What is claimed is:

1. A multifunctional fuel system, comprising:
a multifunctional fuel cartridge, including a hydrogen carrier capable of releasing hydrogen; and
one or more fuel cells, removably coupled to the fuel cartridge;
wherein the one or more fuel cells are capable of producing electricity upon receiving hydrogen from the fuel cartridge and wherein the multifunctional fuel system is additionally adapted to release heat.

2. The multifunctional fuel system of claim 1, further comprising a thermal interface, wherein the multifunctional fuel system is adapted to release heat through the thermal interface.

3. The multifunctional fuel system of claim 1, further comprising a thermal generator, removably coupled to the fuel cartridge, wherein the thermal generator is adapted to generate heat from the hydrogen.

4. The multifunctional fuel system of claim 1, further comprising a thermal generator, removably coupled to the fuel cartridge, wherein the thermal generator is adapted to generate heat from the hydrogen carrier.

5. The multifunctional fuel system of claim 1, further comprising an electric heater, wherein the electric heater is adapted to generate heat from electricity produced by the one or more fuel cells.

6. The multifunctional fuel system of claim 2, wherein the thermal interface is thermally coupled to the fuel cartridge.

7. The multifunctional fuel system of claim 1, further comprising an electrically powered device electrically coupled to the one or more fuel cells.

8. The multifunctional fuel system of claim 7, wherein the electrically powered device comprises a light, a fan, a heater, a USB charger, or combinations thereof.

9. The multifunctional fuel system of claim 7, wherein the electrically powered device comprises a fan, and wherein the fan is adapted to promote movement of the released heat to a surrounding environment.

10. A multifunctional fuel system, comprising:
a fuel cartridge capable of releasing hydrogen;
a catalytic heater, adapted to combust the hydrogen and release heat; and,
at least one fuel cell, adapted to produce electricity using the hydrogen as fuel.

11. A multifunctional fuel cartridge, comprising:
an enclosure, adapted to contain a hydrogen carrier capable of releasing hydrogen;
a fluidic interface for fluidically coupling the storage device to one or more fuel cells; and
a thermal interface for thermally coupling the cartridge to a thermal generator.

12. The multifunctional fuel cartridge of claim 11, wherein the fluidic interface and the thermal interface are integrated.

13. The multifunctional fuel cartridge of claim 11, further comprising an electrical interface for electrically coupling the cartridge with a fuel cell system.

14. The multifunctional fuel cartridge of claim 11, further comprising an electrical interface for electrically coupling the cartridge with a thermal generator.

15. The multifunctional fuel cartridge of claim 11, further comprising a fuel processing component adapted to affect a release of hydrogen from the hydrogen carrier.

16. The multifunctional fuel cartridge of claim 11, wherein the fluidic interface, the thermal interface, or both are adapted to enable removable coupling of the fuel cartridge to the fuel cells or thermal interface.

17. A method of using a multifunctional fuel system, comprising:
releasing hydrogen from a hydrogen carrier contained in a multifunctional fuel cartridge;
contacting one or more fuel cells with the hydrogen;
generating an electrical service from the operation of the one or more fuel cells; and
generating a thermal service from the multifunctional fuel cartridge.

18. The method of claim 17, wherein generating thermal service comprises catalytically combusting the hydrogen.

19. The method of claim 17, wherein generating thermal service comprises reacting the hydrogen released to provide heat.

20. The method of claim 17, wherein generating thermal service comprises generating heat by exothermically reacting the hydrogen carrier.

21. The method of claim 20, further comprising transferring the heat via a thermal interface coupled to the multifunctional fuel cartridge.
